(19) United States
(12) Patent Application Publication
(10) Pub. No.: US 2008/0294466 A1
(43) Pub. Date: Nov. 27, 2008

(54) System and Method of Determining the Annuity Value and Cost for Providing Long-Term Health Care for the Elderly

(75) Inventors: Joshua Z. Hersh, Stamford, CT (US); Ann L. Fowler-Cruz, Sandy Hook, CT (US); Antony R. Mott, New York, NY (US)

Correspondence Address: FOX ROTHSCHILD LLP, P O BOX 592, 112 NASSAU STREET, PRINCETON, NJ, 08542-0592, US

(73) Assignee: HFC GLOBAL SOURCES, White Plains, NY (US)

(21) Appl. No.: 11/569,811

(22) PCT Filed: Jun. 14, 2005
(86) PCT No.: PCT/US05/21042

§ 371 Date: Nov. 30, 2006

Related U.S. Application Data
(60) Provisional application No. 60/580,285, filed on Jun. 16, 2004.

(51) Int. Cl. G06Q 40/00

(52) U.S. Cl. 705/4

(57) ABSTRACT

A system and method of providing care annuities that guarantee provision of actual, appropriate custodial care to individuals. The care annuities are priced based on an estimated cost of providing anticipated, appropriate custodial care for an anticipated time period, such as a Medicaid lookback time. Some or all of the calculations involved in pricing and providing the care annuity, including estimating the type, length and cost of custodial care appropriate for an individual, may be made using a suitably programmed computer. A suitably priced care annuity will guarantee the individual actual, appropriate custodial care for as long as actually required and make business sense to the seller of the annuity. The risk of a possible difference between the estimated and actual cost of providing care may be factored into the price in a statistical manner so that the risk can be spread over a pool of care annuities.

### CROSS REFERENCE TO RELATED APPLICATIONS

This application is related to, and claims priority from, PCT Application PCT/US2005/021043 filed on Jun. 14, 2005, by Joshua Hersh, Ann L. Fowler-Cruz and Antony R. Mott and U.S. Provisional Patent Application No. 60/580,285 filed on Jun. 16, 2004, by Joshua Hersh and Ann L. Fowler-Cruz, entitled “System and Method for Determining Annuity Value and Cost”, the entire contents of which are hereby incorporated by reference.

### FIELD OF THE INVENTION

The present invention relates generally to a system and method of providing for actual custodial care of elderly clients, and particularly to providing for actual custodial care over a period of time via the purchase of a care annuity valued on estimated care needs at or before the time of purchase.

### BACKGROUND OF THE INVENTION

Government programs that pay for, or subsidize, long term care for eligible individuals, such as the U.S. Government's Medicaid program, often have rules that can make financial planning fraught with predicaments, especially for individual attempting to optimize family wealth preservation.

One particularly awkward predicament can result in a previously well-off individual ending up with no money and no long term as a result of miscalculating resources to cover health care requirements during a so-called Medicaid “look back” period. To understand how this may occur, it is useful to review some Medicaid basics.

Medicaid is a state administered program, run under Federal guidelines, that provides, amongst other services, custodial care for eligible individuals. In order to be eligible for Medicaid an individual must have limited assets and income. Moreover, in determining a person's assets, Medicaid administrators will look back at any asset reducing transactions made by the individual and may impose a waiting period penalty related to the value of the assets involved in any such transaction. By law, however, Medicaid administrators can only look back at transactions made within a certain time period called the “look back period”. Although the details may vary from state to state, and be changed from time to time, the following facts indicate the use of a care annuity of this invention.

Typically, Medicaid administrators will not currently pay for nursing home care when a single patient has more than $5,000 in assets. Furthermore, Medicaid administrators are only permitted to look back for a three-year period. So in a simple example, an individual with assets of $500,000 who requires residential care can chose to either pay for that care, at a cost of roughly $10,000 per month, until they have exhausted their assets (after about 50 months, or 4 years and two months in this example) at which point they are eligible for Medicaid. Or they can immediately give away $140,000 to their heirs, keeping $360,000 to pay for three years of nursing home care. At the end of the three years, they can then apply for Medicaid. Because of the three-year limit on look back, Medicaid administrators will not be able to penalize the individual for the $140,000 gift and they will be immediately eligible for Medicaid payment for residential care because they no longer have any assets.

Although the gifting option is clearly attractive to an individual who wishes to transfer assets to heirs, it does have a significant risk, namely that the sum kept for custodial care turns out to be insufficient. For instance, if the individual's condition worsens more rapidly than expected, requiring more expensive care than anticipated then they will not have sufficient funds to cover three years of care. Similarly, if the cost of care rises faster than anticipated they will run out of money.

If the individual does run out money before the end of the three years, they may be in a serious predicament. If they apply for Medicaid, the gift will be within the look back window, and will trigger a penalty period that will run from the date of application. For instance, currently most states impose a penalty period of one month for every $7,000 gifted. In the example above, if the individual runs out of money before the end of three years, and then applies for Medicaid, the $140,000 gift will be within the look back period and will results in a 20 month delay in that individual being eligible from the date of their application for Medicaid. The individual, therefore, has to rely on charity or somehow do without the needed custodial care.

What are needed are ways for individuals to optimize their family wealth preservation without jeopardizing their long term custodial care options.

### SUMMARY OF THE INVENTION

Briefly described, the invention is a system and method of providing for custodial care, particularly for providing care annuities that guarantee provision of actual, appropriate custodial care to individuals whose ability to care for themselves is compromised. In order to provide the care annuities in a competitive environment, an appropriate price of a the care annuities may be calculated based on an estimated cost of providing anticipated, appropriate custodial care for an anticipated time period, which may for instance be a pre-determined time period such as a Medicaid look back time.

In a preferred embodiment of the invention, a computer enabled system estimates the type, length and cost of custodial care appropriate for an individual, and based on that, a suitable price of a care annuity that will guarantee the individual actual, appropriate custodial care for as long as actually required and makes business sense to the seller of the annuity.

The cost of the actual, appropriate custodial care provided may differ from the cost of the estimated, appropriate health care because of factors such as, but not limited to, changes in the cost of custodial care, changes in the type of custodial care required by the individual or changes in the length of time for which the custodial care is required, including changes occasioned by changes to the regulatory requirements. The risk of this possible difference may be factored into the price of the care annuity in a statistical manner so that it can be spread over a pool of care annuities covering a number of individuals.

These and other features of the invention will be more fully understood by references to the following drawings.

### BRIEF DESCRIPTION OF THE DRAWINGS

FIG. 1 is a flow chart showing the steps of providing for custodial care according to a preferred embodiment of the method of the present invention.

FIG. 2 is a flow chart showing the steps of determining the time period of a care annuity according to a preferred embodiment of the present invention.

FIG. 3 is a flow chart showing the steps of determining appropriate custodial care for a time period according to a preferred embodiment of the present invention.

### DETAILED DESCRIPTION

The present invention pertains to methods and systems of providing for custodial care of individuals in failing health, particularly for providing care annuities that guarantee provision of actual, appropriate custodial care to such individuals. The care annuity of this invention is priced based on an estimated cost of providing anticipated, appropriate custodial care for an anticipated time period of custodial care.

One use of such annuities arises from the rules associated with government programs that pay for, or subsidize, long term care for eligible individuals, such as the U.S. Government's Medicaid program.

The care annuity of the present invention is designed to overcome financial planning predicaments such as, but not limited to, those predicaments that might otherwise arise in attempting to maximize family wealth under Medicaid rules. In particular, in a preferred embodiment, the care annuity of the present invention allows an individual who wishes to transfer the maximum amount of assets to heirs to do so with the certainty of obtaining actual custodial care for the entire length of the Medicaid look back period. This is accomplished in the form of a care annuity that is priced approximately equal to the estimated cost of providing appropriate care over a period of time, but which provides a guarantee of actual appropriate care during that time. In a preferred embodiment, the care annuity provides a guarantee of actual, appropriate custodial care for the duration of the Medicaid look back period so that the gifting would not trigger any Medicaid eligibility penalty. In a further preferred embodiment, the care annuity guarantee includes covering changes to costs or time periods occasioned by changes in regulatory requirements such as, but not limited to, changes in the look back time period.

This and other aspects of the invention will now be described in relation to the accompanying drawing in which, as far as possible, like numbers describe like elements.

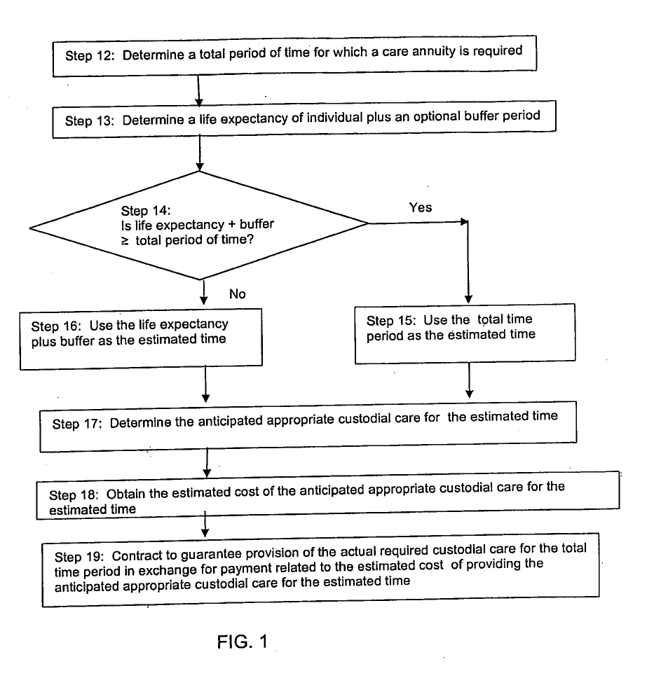

FIG. 1 is a flow chart showing the steps of providing for custodial care according to a preferred embodiment of the method of the present invention. The steps shown in this and the other flow charts of this application may, for instance, be implemented by means of well known hardware and software such as, but not limited to, at least one suitably programmed computing module running on at least on suitable computer, such as a personal commuter or laptop computer, using data input via suitable input devices such as, but not limited to, keyboards, touch screens or a mouse. The computer modules may also obtain data from databases associated with or accessed by the computer. The results of the steps of this and other flow charts may, for instance, be displayed on the computer module, printed out via a printer, or passed on in electronic form for storage, processing or use by another module associated with the computing system.

In step 12, the time period of the care annuity is determined. In a preferred embodiment the total period of time may be the Medicaid look back period in the state in which the individual is resident, or chooses to receive care, and may for instance be selected from a database containing state specific Medicaid information bases on information regarding the individual entered into the system via a suitable computer interface such as, but not limited to, a keyboard, touch screen or voice recognition module.

In step 13 the life expectancy of the individual is determined. In a preferred embodiment, the life expectancy may be obtained based on the individual's age, gender and medical condition using standard actuarial tables of longevity such as, but not limited to, the U.S. Government's National Center for Health Statistics tables on life expectancy. In addition to the estimated life expectancy, a buffer time may also be added. The buffer time may, for instance, be related to the standard deviation of the estimate of the life expectancy, as will be described in more detail below.

In step 14, the individuals life expectancy plus any buffer time is compared to the total period of time for which the care annuity is required.

If the life expectancy plus any buffer time is greater than or equal to the total period of time, then, in step 15, the total period of time is designated as the estimated time for determination of the custodial care in step 17 and the estimation of the cost of the custodial care in step 18.

If the life expectancy plus any buffer time is less than the total period of time, then, in step 16, the life expectancy plus any buffer time is designated as the estimated time for determination of the custodial care in step 17 and the estimation of the cost of the custodial care in step 18.

In step 17 the appropriate custodial care is determined for the estimated time. As discussed in more detail below, the appropriate care may be selected from, for instance, home healthcare assistance, assisted living or nursing home care, or some combination thereof over the estimated time of care. The selection may for instance be made based on a Patient Review Instrument (PRI), which is a standard assessment of an individual's ability to manage Activities of Daily Living (ADL) which typically include feeding, mobility, toileting, bathing, dressing and behavior. The selection may also include expert assessment of anticipated change in the individual's ability to manage ADL based on, for instance, experience or actuarial type tables.

In step 18, an estimate is made of the cost of providing the custodial care that is determined to be appropriate for the duration of the estimated time. This cost may for instance, factor in the location of care facilities and be based on actual costs at actual selected care facilities or it may be based on suitably adjusted statistical estimates of costs, or some combination thereof. The cost may include buffer values based on a suitable statistical metric such as, for instance, the variance in cost.

In step 18, a contract is entered into by the seller of the care annuity to guarantee the provision of the actual custodial care for the individual for whom the care annuity is bought for the total period of time for which the care is required. The care annuity may not be the provider of the care, but guarantees to provide the means for the care. This may be done by, for instance, contracting to provide appropriate payments to the care givers or institutes. The cost of the care annuity is, however, related to the estimated cost of providing what at the time of the purchase of the annuity is estimated to be the appropriate custodial care for the estimated time of the care. The seller of the care annuity may, for instance, act as an insurer, and invest the received premium in low risk or risk free securities such as, but not limited to, state or government bonds. The seller may used the accrued value of the premium to pay the actual custodial care in accordance with the terms of the annuity. Acting as an insurer, the seller of the annuity may assume the risk of errors in the estimates of the cost of care and the length of time for which the care may actually be needed. This risk may, for instance, be assumed by charging an amount that is in excess of the estimated cost of providing the custodial care. This excess may, for instance, be related to uncertainties in the estimates such as, but not limited to, the standard deviation of the estimates.

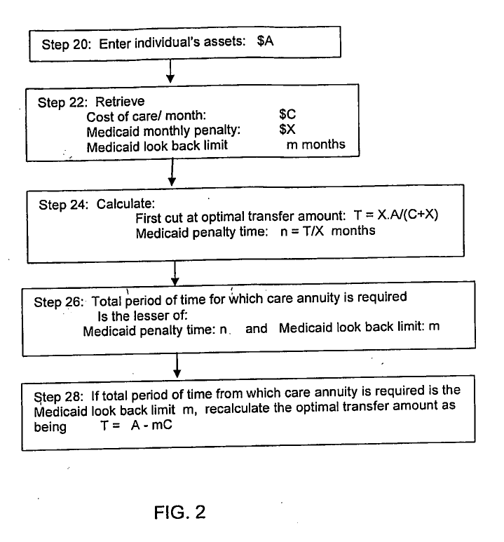

FIG. 2 is a flow chart showing the steps of determining the time period of a care annuity according to a preferred embodiment of the present invention.

In step 20, the individual's assets are entered. In a preferred embodiment, these are the individual's total non-exempt assets under the prevailing Medicaid rules, or the rules of an long term provider operating rules similar to Medicaid.

In step 22, the prevailing values are retrieved from, for instance, an appropriate database for the following: C, the estimated monthly cost of the estimated appropriate custodial care over the time period of the care will be needed; X, the Medicaid monthly penalty figure, i.e., there is one month time penalty in becoming eligible for Medicaid for every $X transferred within the look-back period; and m, the Medicaid look-back period in months.

In step 24, calculations are made to arrive at a first cut for the optimal amount of money to transfer using a formula such as:

T=X·A/(C+X)

Where T represents the amount of money to transfer, X is the Medicaid monthly penalty figure, A are the total assets and C is the monthly cost of the appropriate custodial care. Once the optimal transfer amount is determined, the Medicaid penalty time in months, n, that that transfer will trigger is calculated using the formula:

n=T/X

In step 26 the total time period for which the care annuity is required is selected as the lesser of the Medicaid penalty time n and the Medicaid look back time m.

In step 28, the optimal transfer amount T is recalculated if the total time period for which care annuity is required is the Medicaid look back time m, using the formula:

T=A−mC

Once the total time period for which a care annuity is required has been found based on regulatory rules according to a method such as the method shown in FIG. 2, an individual life expectancy may be calculated that factors in the individual's medical and other particular risk factors. Such methods of calculating impairment based individualized mortality are well-known and described in, for instance, U.S. Pat. No. 6,615,180 issued on Sep. 2, 2003 to Anderton et al., entitled “Process and Apparatus for the Derivation of Annuity Rates”, the contents of which are hereby incorporated by reference.

In addition to calculating an estimated life expectancy, a buffer time period may be calculated. This buffer time period may, for instance, reflect a statistical uncertainty in the life expectancy estimate and allow a provider of a care annuity a margin of error in estimating costs. One method to calculate a buffer time period is the algorithm of table 1.

TABLE 1
Algorithm for calculating a buffer time period.
Γ αN(d₁) − βe^{δt}N(d₂)
where
$\begin{matrix}{d}_{1} = \frac{ln \frac{α}{β} + ( - δ + \frac{{σ}^{2}}{2} ) t}{σ \sqrt{t}} \\ {d}_{2} = \frac{ln \frac{α}{β} + ( - δ - \frac{{σ}^{2}}{2} ) t}{σ \sqrt{t}}\end{matrix}$
Γ = suggested buffer in months
α = expected number of months of care required
β = number of months for annuity base
σ = volatility of α expressed as a percentage
N = cumulative normal distribution function
δ = annual rate at which the average life expectancy is increasing
t = length of annuity

An algorithm for calculating a buffer time period shown in table 1, relates the suggested buffer time period to the expected number of months of care required, which may be the individual's actuarially estimated life expectancy, using a measure of the volatility of that estimate, using a cumulative normal distribution function and a measure of the annual rate at which the average life expectancy is increasing. The measure of volatility may, for instance, be the standard deviation of the estimate.

Use of the algorithm of table 1 for calculating a buffer time period will be illustrated by the following example.

### EXAMPLE 1

### Care Annuity for a Nursing Home

A patient wishes to purchase a care annuity for actual care in a nursing home. The patient presents a condition of moderate Alzheimer's, is partly-mobile and incontinent. Actuarial statistics, based on, for instance, age, gender and these medical facts, indicate that the patient will survive 24 months, with a standard deviation, expressed as a percentage, of 18%. Independent medical opinion confirms that the patient requires custodial care in a nursing home, and estimates that the patient will survive 24 months. Based on this: the variable α is estimated to be 24; the variable β is estimated to be 24; and the variable σ is estimated to be 18%.

Trends in actuarial tables indicate that average life expectancy is increasing by 0.01 annually. Based on this, the variable δ is estimated to be 1%.

The life of the annuity is to be three years. Base on this, the variable t is estimated to be 3 years.

The charge-rate per month for nursing home care is estimated to be $10,000 for each month.

To determine Γ, we input the above variables into the algorithm, as described in table 1:

Γ=24×N(d₁)−24×e^{0.01×3}N(d₂)

where

$${d}_{1} = \frac{ln \frac{24}{24} + {( - 0.01 + \frac{{0.18}^{2}}{2} )}^{3}}{0.18 \sqrt{3}} ≃ 0.15588$$

$${d}_{2} = \frac{ln \frac{24}{24} + {( - 0.01 - \frac{{0.18}^{2}}{2} )}^{3}}{0.18 \sqrt{3}} ≃ - 0.15588$$

The result of this calculation is a buffer period of 3.064 months, so that the total expected time period is 27.064 months. As this is less then the Medicaid three year look back period, this figure may then be used in calculating the expected cost of the care and hence the cost of the annuity.

The cost of the care annuity in this case may therefore be calculated as the total time multiplied by the expected monthly charge, i.e., (24+3.064)·(10,000) for a total of $270.064.

For this payment, the patient is then guaranteed the nursing home care for as long as needed, and includes any cost increases.

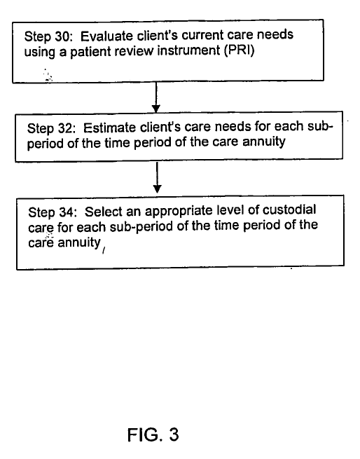

FIG. 3 is a flow chart showing the steps in estimating the type of custodial care. In step 30 the individual's current care needs are evaluated. This may, for instance, be done using a well-known Patient Review Instrument (PRI). This is a method of scoring a patent's care requirement needs that typically consists of a series of multiple choice questions requiring a check off answer for each question. Typically there are five choices, answers to which score values ranging from zero to four, and in which lower scores indicate lower care requirements. The PRI may cover medial events as well as activities of daily living (ADL), behaviors and specialized services. The ADL typically cover the individual's ability to function in categories including eating, mobility, transfer and toileting. Behaviors may include assessment history of verbal disruption, physical aggression, socially inappropriate behavior and hallucinations. Specialized services may include the need for physical or occupational therapy.

In step 32, an estimate may then be made of the likely care needs through out the time period of the care annuity. For instance, an individual currently requiring only home care, may be assessed to be likely to progress through the need for assisted living and nursing home care based on the like progression of a medical condition. This may be done based in part on factors such as, but not limited to the individual's age, gender and race, as well as actuarial data related to the progression of various medical conditions. This progression in care needs may be expressed as a predicted increase in the individual's aggregate PRI score over time.

In step 34, based on an individual's aggregate PRI score, an appropriate level of custodial care may be selected from options such as, but not limited to, home care, assisted living, nursing home care or hospital care. The estimated progression of level of custodial care may be calculated based on the estimated change in aggregate PRI score over time obtained in step 32.

The above-described steps can be implemented using standard well-known programming techniques. The novelty of the above-described embodiment primarily lies not in the specific programming techniques but in the use of the steps described to achieve the described results. Software programming code which embodies the present invention may stored in permanent memory of some type, such as permanent storage of a workstation. In a client/server environment, such software programming code may be stored in memory associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A programmed computer system, comprising:
computing means for estimating a total period of time for which an individual will require custodial care;
computing means for selecting an anticipated, appropriate custodial care for said individual;
computing means for estimating a cost of providing said anticipated, appropriate custodial care for said total period of time; and
computer means for calculating an offer price for a care annuity guaranteeing provision of actual, appropriate custodial care required by said individual.

2. The programmed computer system of claim 1, wherein said offer price is substantially equal to said cost.

3. The programmed computer system of claim 1 wherein said offer price further includes a premium.

4. The programmed computer system of claim 1 wherein said means for estimating a total period of time further comprises estimating a life expectancy of said individual.

5. The programmed computer system of claim 4 wherein said means for estimating a total period of time further includes estimating a buffer period of time related to a volatility of said life expectancy estimate.

6. The programmed computer system of claim 1 wherein said means for selecting an anticipated, appropriate custodial care comprises evaluating said individual's ability to deal with at least one activity of daily living.

7. The programmed computer system of claim 6 wherein said at least one activity of daily living is eating, mobility, transfer or toileting, or some combination thereof.

8. The programmed computer system of claim 7 wherein said anticipated, appropriate custodial care is a nursing home, assisted living or home care, or some combination thereof.

9. A method of providing for actual, appropriate custodial care required by an individual, said method comprising the steps of:
estimating a total period of time for which said custodial care will be required;
selecting an anticipated, appropriate custodial care for said individual;
estimating a cost of providing said anticipated, appropriate custodial care for said total period of time; and
estimating a price for a care annuity guaranteeing provision of said actual appropriate custodial care required by said individual for as long as actually required.

10. The method of claim 9 wherein said estimated price is substantially equal to said estimated cost.

11. The method of claim 10 wherein said price further includes a premium.

12. The method of claim 9 wherein said step of estimating a total period of time further comprises the step of estimating a life expectancy of said individual.

13. The method of claim 12 wherein said step of estimating a total period of time further comprises a buffer period of time related to a volatility of said life expectancy estimate.

14. The method of claim 9 where said step of selecting an anticipated, appropriate custodial care further comprises the step of evaluating said individual's ability to deal with at least one activity of daily living.

15. The method of claim 14 wherein said at least one activity of daily living is eating, mobility, transfer or toileting, or some combination thereof.

16. The method of claim 15 wherein said anticipated, appropriate custodial care is a nursing home, assisted living or home care, or some combination thereof.

17. A system of providing for actual, appropriate custodial care required by an individual, comprising:
an estimation module setup to calculate a total period of time for which said custodial care will be required;
a selection module setup to choose an anticipated, appropriate custodial care for said individual;
a cost module setup to calculate a cost of said anticipated, appropriate custodial care for said total period of time; and
a pricing module set up to price a care annuity guaranteeing provision of said actual appropriate custodial care required by said individual for as long as actually required.

18. The system of claim 17 wherein said estimation module further calculates a life expectancy and a buffer period of time related to a volatility of said life expectancy estimate.

19. The system of claim 9 wherein said selection module comprises scoring said individual's ability to deal with at least one activity of daily living.
